(19) United States
(12) Patent Application Publication
(10) Pub. No.: US 2018/0170309 A1
(43) Pub. Date: Jun. 21, 2018

(54) USER NOTIFICATION OF POWERED SYSTEM ACTIVATION DURING NON-CONTACT HUMAN ACTIVATION

(71) Applicant: Magna Closures Inc., Newmarket (CA)

(72) Inventors: Gerard McMahon, Aurora (CA); Liviu Bolbocianu, North York (CA); Samuel R. Baruco, Aurora (CA); Pratibha Jagdish Pose, Thornhill (CA)

(21) Appl. No.: 15/896,426

(22) Filed: Feb. 14, 2018

Related U.S. Application Data
(63) Continuation-in-part of application No. 15/696,657, filed on Sep. 6, 2017.
(60) Provisional application No. 62/384,930, filed on Sep. 8, 2016.
(60) Provisional application No. 62/460,247, filed on Feb. 17, 2017.
(60) Provisional application No. 62/610,655, filed on Dec. 27, 2017.

(51) Int. Cl. B60R 25/01; B60Q 1/50; B60R 25/20; B60R 25/24; E05F 15/73

(52) U.S. Cl. CPC B60R 25/01; B60Q 1/50; B60R 25/2054; G01S 17/88; B60R 25/245; E05F 15/73; B60R 25/2045

(57) ABSTRACT

The present disclosure relates to a non-contact power closure member system for operating a liftgate of vehicle. The non-contact power closure member system includes at least one sensor for sensing an object or motion when a key fob is located within a predetermined distance of the vehicle. An indicator is located on the vehicle to inform the user of the appropriate location to make an activation gesture. The system also includes an electronic control unit connected to the at least one sensor and executing software. The electronic control unit processes the data to determine if the gesture made by the user is the activation gesture required to open the liftgate, or a false signal. In response to the activation gesture, the electronic control unit initiates opening of the liftgate. Methods are provided for operating the liftgate of a vehicle using a non-contact power closure member system.

### CROSS-REFERENCE TO RELATED APPLICATIONS

This utility application is a continuation-in-part of U.S. Ser. No. 15/696,657, filed Sep. 6, 2017 which claims priority to U.S. Provisional Application No. 62/384,930, filed Sep. 8, 2016 and this utility application claims the benefit of U.S. Provisional Application No. 62/460,247 filed Feb. 17, 2017 and U.S. Provisional Application No. 62/610,655 filed Dec. 27, 2017. The entire disclosures of the above applications are incorporated herein by reference.

### BACKGROUND

### 1. Field of the Invention

The present disclosure relates generally to power closure member systems for motor vehicles and, more particularly, to a user-activated, non-contact power closure member system for moving a closure member relative to a vehicle body between a closed position and an open position or from the open position to the closed position.

### 2. Related Art

This section provides background information related to the present disclosure which is not necessarily prior art.

Motor vehicles, such as sports utility vehicles, can be designed to include a user-activated, non-contact power closure member system (e.g., power liftgate system) for automatically opening a closure member of the vehicle. The power closure member system includes a sensor to detect motion of the user desiring to open the closure member, for example a kicking motion of the user's foot beneath a rear bumper in the event that the closure member is a rear liftgate. The system includes technology to confirm the user, who is in possession of a key fob associated with the vehicle, is the source of the motion, so that the closure member is not incorrectly activated, for example by another human, animal, weather conditions, or objects which could enter the space beneath the bumper. The system allows for convenient, user-friendly opening of the closure member when the user's hands are occupied, for example when the user is holding items to be loaded in the vehicle. However, the user-activated, non-contact power closure member systems which are currently available could be improved.

### SUMMARY

This section provides a general summary of the present disclosure and is not a comprehensive disclosure of its full scope or all of its features, aspects and objectives.

Accordingly, it is an aspect of the present disclosure to provide a user-activated non-contact power closure member system for detecting a gesture and operating a closure member a vehicle. The system includes at least one non-contact sensor attached to a vehicle body for detecting at least one of an object and motion corresponding to the gesture made by a user and outputting data in response to detecting the at least one of the object and the motion. The at least one non-contact sensor includes a radar based gesture recognition subassembly for providing an intermediate radar field within a predetermined distance from the radar based gesture recognition subassembly in which the user can interact. An indicator is attached to the vehicle body for informing the user of an appropriate location to make the gesture. An electronic control unit is coupled to the indicator and the at least one non-contact sensor and is configured to receive and analyze the data output by the at least one non-contact sensor. The electronic control unit is also configured to determine whether the data corresponds with an activation gesture to transition to a triggering event mode defined by the gesture made by the user corresponding to the activation gesture and a non-triggering event mode defined by the gesture not corresponding to the activation gesture and initiate movement of the closure member in response to transitioning to the triggering event mode. The electronic control unit is additionally configured to notify the user using the indicator.

It is another aspect of the present disclosure to provide a method for operating a closure member of a vehicle using a non-contact power closure member system including an indicator and a non-contact sensor including a radar based gesture recognition subassembly and an electronic control unit. The method includes the step of detecting a key fob associated with the vehicle within a predetermined distance of the vehicle. Next, notifying a user to present a gesture using the indicator. The method proceeds by generating an intermediate radar field adjacent to the vehicle using the radar based gesture recognition subassembly and detecting the gesture in the intermediate radar field made by the user. The method also includes the steps of determining a time frame for the gesture made by the user and comparing the gesture with an activation gesture and the time frame with a required period of time required to initiate a triggering-event mode for operating the closure member of the vehicle.

The user-activated, non-contact power closure member system according to the present disclosure provides numerous benefits, which are especially attractive to a user of the vehicle. Due to the indicator, also referred to as an icon, the user is now aware of whether the system is activated, in motion, and/or waiting for a gesture signal, such as a kicking motion, as they approach the vehicle. The user is also informed that they are making the activation gesture in the correct location, and that the activation gesture has been received by the system.

These and other aspects and areas of applicability will become apparent from the description provided herein. The description and specific examples in this summary are intended for purpose of illustration only and are not intended to limit the scope of the present disclosure.

In accordance with another aspect of the present disclosure, the system includes at least one sensor for sensing at least one of an object and motion adjacent the closure member and outputting data corresponding to at least one of an object and motion. At least one indicator is disposed on the vehicle. An electronic control unit is coupled to the at least one sensor and the at least one indicator is configured to receive and process data corresponding to the at least one of the object and motion from the at least one sensor. The electronic control unit is also configured to determine whether the data associated with the at least one of the object and motion is a correct activation gesture required to move the closure member. Additionally, the electronic control unit is configured to initiate movement of the closure member in response to the at least one of the object and motion being the correct activation gesture with the correct activation gesture including the at least one of the object and the motion being adjacent to the at least one sensor and the at least one of the object and the motion being nonadjacent to the at least one sensor after a predetermined period of time. The electronic control unit is also configured to notify the user using the at least one indicator. The valid activation gesture may also include the object having no motion during the predetermined period of time.

According to another aspect of the present disclosure is a method of operating a closure member of a vehicle using a non-contact power closure member system. The method begins by detecting at least one of an object and a motion located adjacent the closure member using at least one sensor. The method continues with the step of determining whether data associated with at least one of the object and the motion is an activation gesture which is required to initiate opening of the closure member, with the activation gesture including the at least one of the object and the motion being adjacent to the at least one sensor and the at least one of the object and the motion being nonadjacent to the at least one sensor after a predetermined period of time. The method continues by initiating movement of the closure member in response to determining that the data associated with the at least one of the object and the motion is a correct activation gesture. The method also includes the step of notifying the user.

### DRAWINGS

Other advantages of the present disclosure will be readily appreciated, as the same becomes better understood by reference to the following detailed description when considered in connection with the accompanying drawings wherein:

FIG. 1 is a perspective view of an example motor vehicle equipped with a user-activated, non-contact power closure member system for opening a rear liftgate of the vehicle which shows the location of at least one sensor and is constructed in accordance with the teachings of the present disclosure;

FIG. 2 is another perspective view of an example motor vehicle equipped with the user-activated, non-contact power closure member system for opening the rear liftgate of the vehicle which shows the location of an indicator and is constructed in accordance with the teachings of the present disclosure;

FIG. 3 is an enlarged view of a portion of the motor vehicle including the indicator shown in FIG. 2;

FIG. 4 is an enlarged view of a portion of an example bumper assembly of a motor vehicle having a user-activated, non-contact power closure member system constructed in accordance with the teachings of the present disclosure and which includes a graphic illuminated during activation (wake-up) and operation of the system;

FIG. 5A is an exploded view of an example user-activated, non-contact power closure member system including a single sensor which is mounted on a rear bumper and is constructed in accordance with the teachings of the present disclosure;

FIG. 5B is an exterior view of the example user-activated, non-contact power closure member system shown in FIG. 5A;

FIG. 6A is an exterior side view of an example graphic of a user-activated, non-contact power closure member system including a pair of sensors constructed in accordance with the teachings of the present disclosure and which is mounted on a rear bumper, and wherein the bumper has clearance slots for ultrasonic waves conveyed to and/or from the sensors;

FIG. 6B is a perspective view from inside the rear bumper of an electronic control unit and the pair of sensors of the system of FIG. 6A;

FIG. 6C is an exterior bottom view of the clearance slots of the rear bumper of FIG. 6A;

FIG. 7A is an exterior side view of an example graphic of a user-activated, non-contact power closure member system including a single sensor constructed in accordance with the teachings of the present disclosure and which is mounted on a rear bumper, and wherein the bumper has a clearance slot for ultrasonic waves conveyed to and/or from the sensor;

FIG. 7B is a perspective view from inside the rear bumper of an electronic control unit and the sensor of the system of FIG. 7A;

FIG. 7C is an exterior bottom view of the clearance slot of the rear bumper of FIG. 7A;

FIG. 8 illustrates an example optional trim bezel which can be installed around a graphic of a user-activated, non-contact power closure member system constructed in accordance with the teachings of the present disclosure to cover manufacturing defects and/or misalignments;

FIG. 9 is a perspective view of an example motor vehicle equipped with the user-activated, non-contact power closure member system for opening a rear liftgate of the vehicle which shows the location of an indicator including a radar based gesture recognition system and is constructed in accordance with the teachings of the present disclosure;

FIG. 10 is a schematic diagram of a radar based gesture recognition subassembly utilizing continuous wave Doppler based radar, in accordance with an illustrative and non-limiting embodiment of the present disclosure;

FIG. 11 is a schematic diagram of another radar based gesture recognition subassembly utilizing continuous wave, frequency-modulated radar, in accordance with an illustrative and non-limiting embodiment of the present disclosure;

FIG. 12 is a schematic diagram of another radar based gesture recognition subassembly utilizing continuous wave, frequency-modulated radar, in accordance with an illustrative and non-limiting embodiment of the present disclosure;

FIGS. 13 and 14A-14B are flow charts illustrating the steps of a method of operating a closure member of a vehicle using the non-contact power closure member system in accordance with the teachings of the present disclosure;

FIG. 15 illustrates examples of timing of a first and second detection of a gesture by an example embodiment of the non-contact power closure member system in accordance with the teachings of the present disclosure; and

FIG. 16 illustrates examples of timing of a first and second detection of the gesture by another example embodiment of the non-contact power closure member system in accordance with the teachings of the present disclosure.

### DETAILED DESCRIPTION

In general, several example and non-limiting embodiments of a user-activated, non-contact power closure member system constructed in accordance with the teachings of the present disclosure will now be disclosed. A method of operating a closure member of a vehicle using the non-contact power closure member system constructed in accordance with the teachings of the present disclosure will also be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail. Also, the system could alternatively be used to open and/or close another closure element, such as, but not limited to a sliding door or a power swing door of the vehicle.

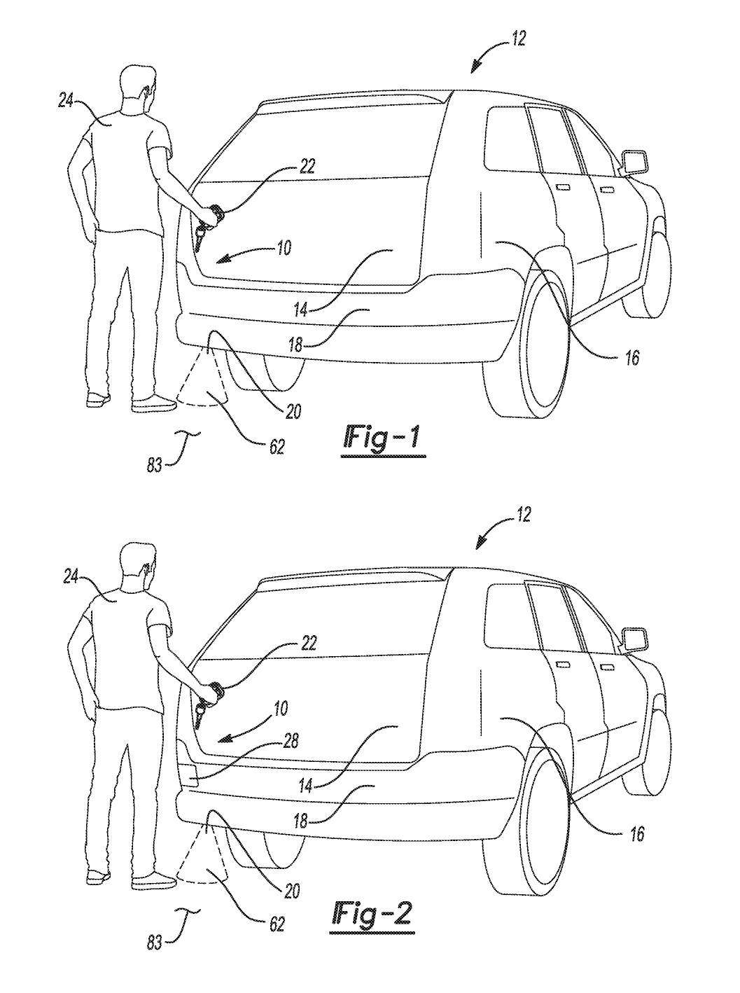

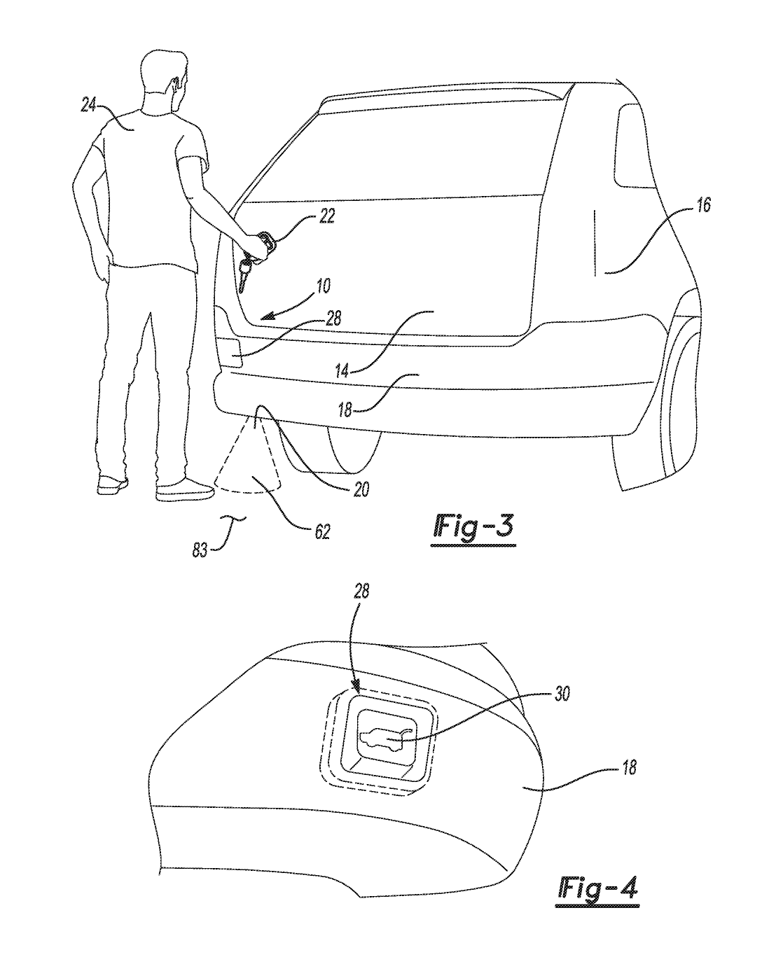

Referring initially to FIGS. 1-4, an example motor vehicle 12 is shown to include a closure member being a rear liftgate 14 mounted for pivotal movement relative to a vehicle body 16. According to an example embodiment described in the present disclosure, the non-contact power closure member system 10 is integrated into a rear bumper 18 of the vehicle body 16 and used for controlling movement of the rear liftgate 14. However, the non-contact power closure member system 10 could be placed at another location, for example, and used for the rear liftgate 14 or used for a different closure member.

The non-contact power closure member system 10 includes at least one sensor 20 which senses an object or motion when a key fob 22 associated with the specific vehicle 12 is located within a predetermined distance of the vehicle 12, for example when the key fob 22 is in possession of a user 24 approaching the vehicle 12. Although the key fob 22 is used in the example embodiment, another component associated with the specific vehicle 12 and which can be detected by the vehicle 12 could be used or it may be possible to otherwise initialize the system 10 without using the key fob 22. An example of the object detected by the at least one sensor 20 is a foot of the user 24, and an example of the motion detected by the at least one sensor 20 in a detection zone 62 is a kicking or waving motion or step of the user 24 or a combination thereof. Another example may be a motion detection followed by a non-waving, stationary motion detection, for example representing a step into the detection zone 62, and vice versa. It should be appreciated that other objects and/or motions, and combinations thereof may be alternatively utilized.

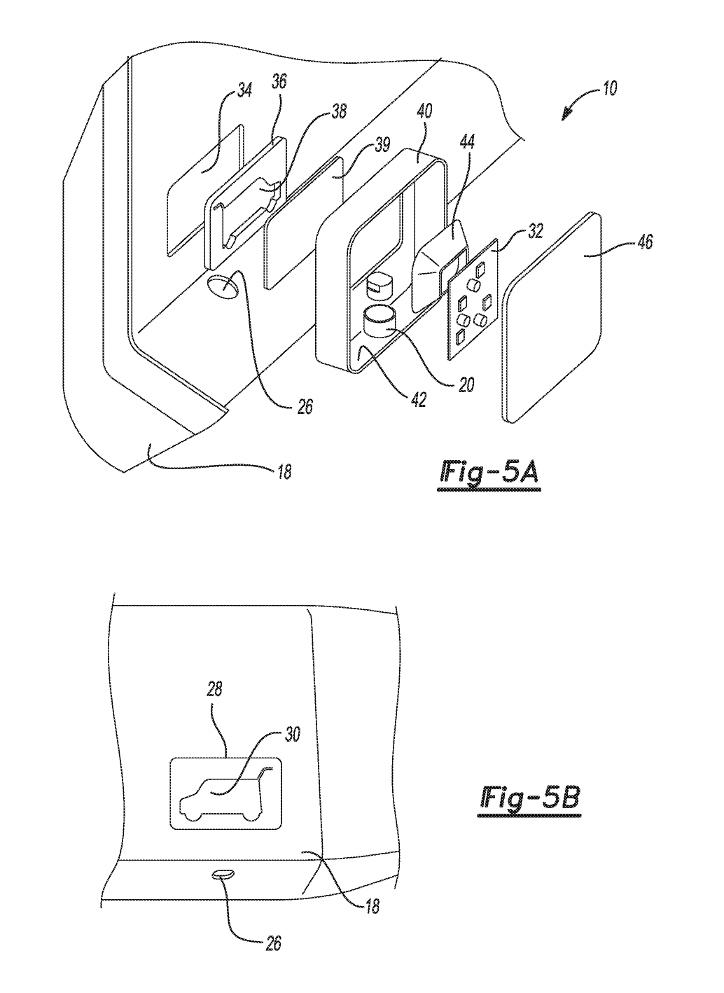

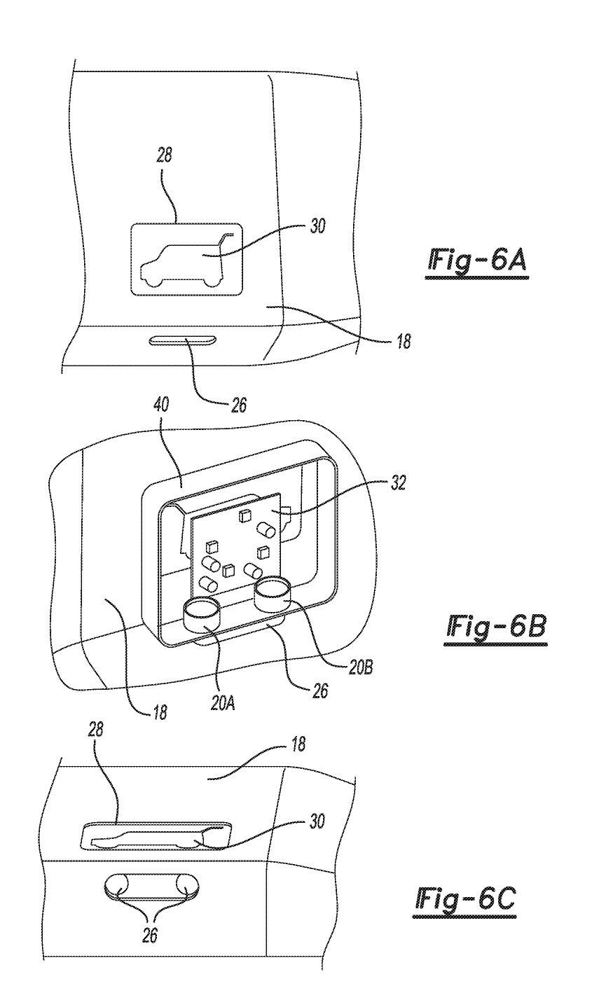

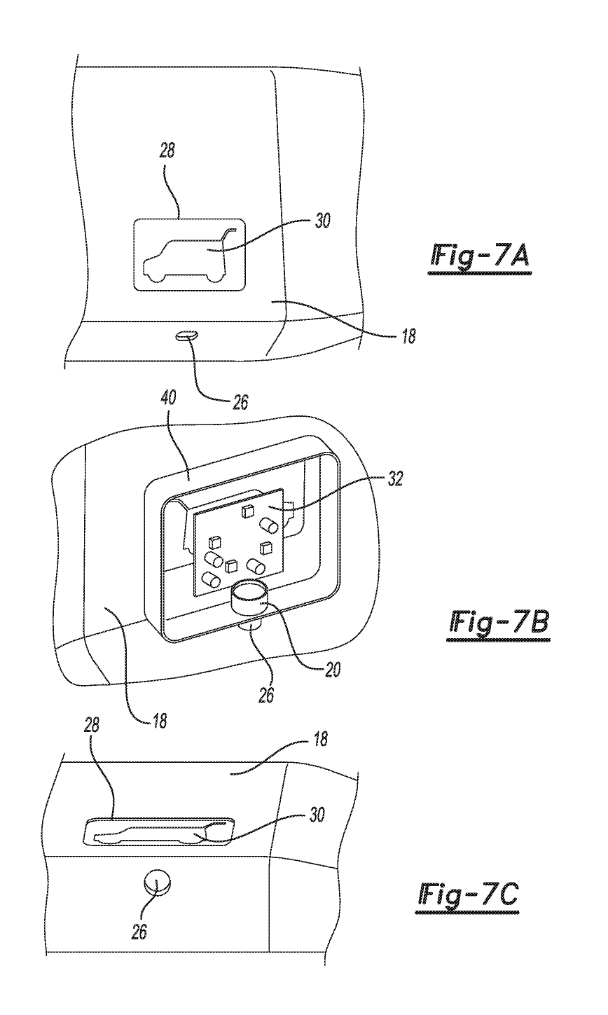

The at least one sensor 20 can comprise various different types of non-contact sensors in the non-contact power closure member system 10 constructed in accordance with the present disclosure. For example, the at least one sensor 20 could be an ultrasonic, capacitive, radar sensor, or another type of proximity sensor capable of detecting an object or gesture in the detection zone 62 without requiring physical contact. When the at least one sensor 20 is an ultrasonic sensor, the rear bumper 18 can include a clearance slot 26, as best shown in FIGS. 5-7, to allow ultrasonic waves to be conveyed to and/or from each sensor 20, for example between the rear liftgate 14 and the ground 83. Optionally, in the case of a radar based system described herein below, the clearance slot 26 can be eliminated leaving the surface of the rear bumper 18 undisturbed. According to one embodiment, the non-contact power closure member system 10 includes a single ultrasonic sensor 20, as shown in FIGS. 5A-5C and 7A-7C. According to one embodiment, the non-contact power closure member system 10 includes a pair of ultrasonic sensors 20A, 20B, referred to as dual sensors, as shown in FIGS. 6A-6C. In this embodiment, one of the sensors transmits (Tx) and the other one of the sensors receives (Rx) or listens. The dual sensors 20A, 20B provide the system 10 with an advantage over comparative systems which only include a single ultrasonic sensor. If there is only a single ultrasonic sensor, due to close range, feedback which interferes with operation can occur. The dedicated transmit and receive sensors 20A, 20B eliminate this feedback/ringing problem.

As best shown in FIGS. 2-8, the non-contact power closure member system 10 also includes an indicator 28 located on the vehicle 12 to inform the user 24 of the appropriate location to make an activation gesture which initiates opening of the closure member (e.g., rear liftgate 14). The activation gesture could be a movement made by the user 24, and/or or an object placed by the user 24 adjacent the at least one sensor 20. In the example embodiments, the indicator 28 is located adjacent the at least one sensor 20, for example on the rear bumper 18 of the vehicle 12. The indicator 28 can also inform the user 24 if the system 10 is activated or powered up, during system wake-up, in motion, has detected the user 24 approaching the vehicle 12, that the system 10 is receiving input from the user 24, if the user 24 has made an incorrect or invalid gesture or motion, and/or if the system 10 is waiting for the activation gesture signal. The indicator 28 of the example embodiment includes a graphic 30, also referred to as an icon, for example a lighted picture of an opened rear liftgate 14, to alert the user 24. In this embodiment, the indicator 28 is referred to as ICON. The use of an actual icon located properly provides the user 24 with a visual indicator of where the at least one sensor 20 is located. This feature is beneficial to the user 24 and provides an advantage over comparative systems, which require the user 24 to guess where the at least one sensor 20 is located below a rear bumper 18.

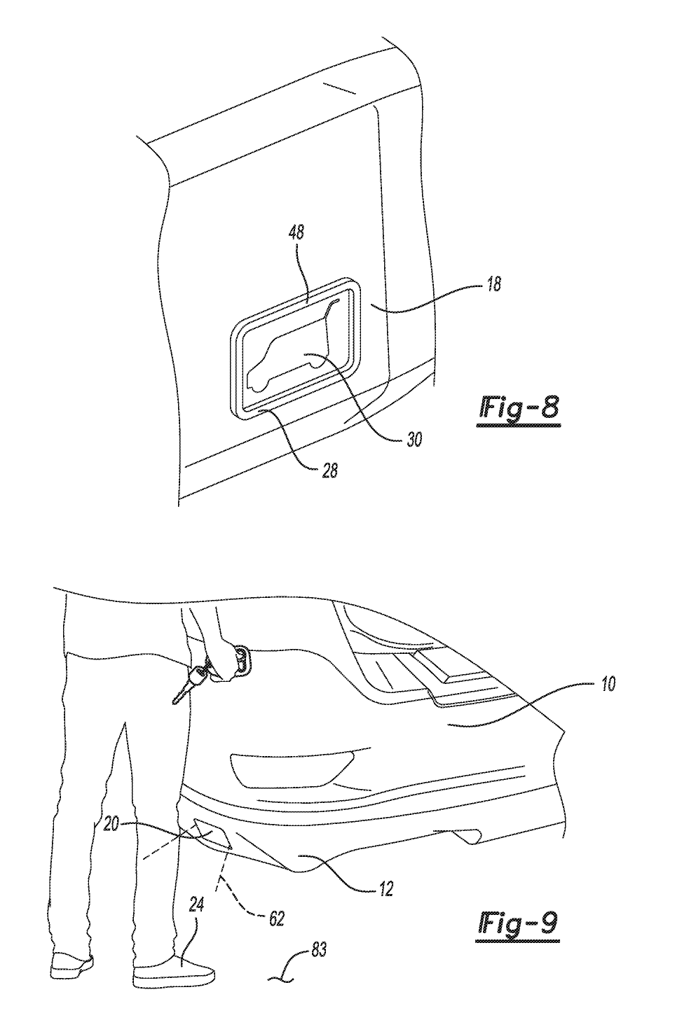

An exploded view of the user-activated, non-contact power closure member system 10 with one ultrasonic sensor 20 according to the example embodiment is shown in FIG. 5A. The system 10 includes the rear bumper 18 with an opening 34 for various components of the sensor 20 and the clearance slot 26 for ultrasonic waves transmitted to and/or from the ultrasonic sensor 20. An image cover 36 is disposed over the opening 34 which includes a cutout 38 of the graphic 30, in this case the vehicle 12 with the opened rear liftgate 14. The image cover 36 is also painted to match the color of the vehicle body 16. An image diffuser 39, for example a translucent white plastic, is disposed over the image cover 36. Next, a housing 40 is disposed over the image diffuser 39. The ultrasonic sensor 20 is contained in the housing 40 and rests on a base wall 42 of the housing 40. A reflector 44 which directs light to the image or area of the graphic 30 is also disposed in the housing 40 adjacent the sensor 20. The electronic control unit 32 is also disposed in the housing 40. In the example embodiment, at least one light emitting diode is located on the far side of the electronic control unit 32. A cover 46 is disposed over the housing 40. As shown in FIG. 5B, which is an exterior view of the system 10 of FIG. 5A, the graphic 30 is visible through the cover 46. As shown in FIG. 8, the system 10 optionally includes a bezel 48 installed from the exterior of the rear bumper 18 to cover any manufacturing defects and/or misalignments that may be present.

An audible warning tone, honk, or beep can also be used, with or without the graphic 30, to alert the user 24. The indicator 28 can also include other features or components to notify the user 24, for example another type of light or lighted area along or near the rear bumper 18, tail lights, reverse lights, signal lights, an object or projection on a glass of the vehicle 12, for example a projected image or light. According to one example embodiment, the indicator 28 has a different color in the ON and OFF state and provides the user 24 with an idea of where to place his or her foot. Additionally, the indicator 28 used to notify the user 24 may be any other area on the vehicle 12 that could be visible to the user 24. In summary, various options are possible for the feature or features used as an indicator 28 to notify the user 24. The key point is that feedback is provided to the user 24 for foot detection.

According to the example embodiment, as the user 24 approaches the vehicle 12, the vehicle 12 senses the key fob 22 and powers on the non-contact power closure member system 10. Once the system 10 wakes up, the at least one sensor 20 and indicator 28 are activated. In the example embodiment, the indicator 28 is a lighted picture, in the example shown is an image of an open liftgate representing the vehicle system that will be operated, on the rear bumper 18 to notify the user 24 that the system 10 is activated and waiting for the activation gesture from the user 24 to open the rear liftgate 14. The indicator 28 also notifies the user 24 of the correct position to perform the activation gesture, which in this case is the presence of a foot. It should be understood that the activation gesture could also include the foot of the user 24 being placed adjacent to the at least one sensor 20 (i.e., a step-in of the detection zone 62) and the foot of the user 24 being moved nonadjacent to the at least one sensor 20 (i.e., a step out of the detection zone 62) after a predetermined period of time during which time period the foot of the user 24 may optionally not move, or is held stationary for a period of time. The user 24 then places his or her foot under the lighted indicator 28. Once the foot is detected, the indicator 28 flashes and optionally an audible tone can be made by the system 10 or another component of the vehicle 12 to indicate the presence of the foot. The user 24 then leaves his or her foot stationary for a required period of time needed to initiate opening of the rear liftgate 14. On the other hand, if the user 24 leaves his or her foot stationary but does not meet the required period of time, i.e. less than the period of time needed to initiate the opening of the rear liftgate 14, the indicator 28 flashes and optionally an audible tone can be made by the system 10 or another component of the vehicle 12 to indicate that the gesture made by the user does not meet the requirement for opening the rear liftgate 14.

The system 10 also includes an electronic control unit 32 executing software and connected to the at least one sensor 20. According to an aspect, the electronic control unit 32 is separate from and in communication with a power closure member electronic control unit (not shown) and the electronic control unit 32 can initiate the opening of the closure member (e.g., rear liftgate 14) by communicating with the power closure member electronic control unit; however, it should be appreciated that the electronic control unit 32 itself could instead control the rear liftgate 14 or the functions of the electronic control unit 32 could alternatively be carried out by the power closure member electronic control unit. When an object or motion and characteristics (e.g., speed, angle, size, etc.) of the object in the detection zone 62 is detected by the at least one sensor 20, such as the foot, the at least one sensor 20 sends data related to the object or motion (and characteristics) to the electronic control unit 32 (i.e., software). The electronic control unit 32 processes the data from the at least one sensor 20 to determine if the object or motion is the activation gesture required to open the rear liftgate 14, rather than a false signal (e.g. passing debris, a cat or other object walking past the sensor) or incorrect gesture. If the data indicates the presence of the correct activation gesture, the electronic control unit 32 initiates opening of the rear liftgate 14. In the example embodiment, when the rear liftgate 14 about to open or opening, the indicator 28, for example the lighted graphic 30 and audible tone, are activated to notify the user 24.

According to the example embodiment, the software first establishes a baseline measurement, which can be a distance between the at least one sensor 20 and the ground 83 beneath the rear liftgate 14 without any obstacles. The system 10 then continues to monitor the sensor data and looks for a change in the baseline measurement that exceeds a given threshold distance. Once the threshold distance has been exceeded, the electronic control unit 32 perceives this as the correct activation gesture, rather than a false signal, and communicates to the power liftgate electronic control unit that an opening or closing request has been given. If the detected data does not meet the threshold set, then the electronic control unit 32 determines a false signal occurred, for example which could occur by an object (e.g., a foot of the user 24) unintentionally moving beneath the rear bumper 18. After the correct activation signal is communicated to the electronic control unit 32, the electronic control unit 32 can then initiate the opening of the rear liftgate 14. According to the example embodiment, the system 10 again flashes the indicator 28 and makes the audible tone to indicate opening of the rear liftgate 14, and the rear liftgate 14 opens.

As best shown in shown in FIGS. 9-12, a radar based gesture recognition subassembly 25, 25′, 25″ can alternatively be used in the non-contact power closure member system 10 as a type of the at least one non-contact sensor 20 in conjunction with the indicator 28. In addition, the radar based gesture recognition subassembly 25, 25′, 25″ can be used in ICON type applications. The radar based gesture recognition subassembly 25, 25′, 25″ can be integrated along with the indicator 28 or, alternatively, separately attached to the rear bumper 18 or another location on the vehicle 12.

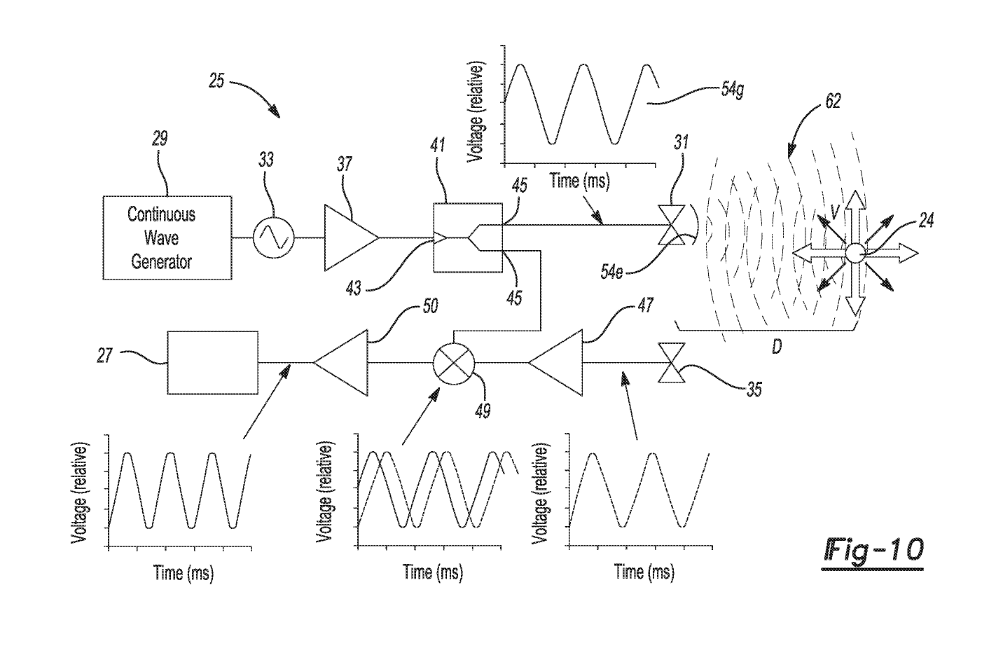

According to an aspect, an example of the radar based gesture recognition subassembly 25 includes a waveform generator 29 for generating a waveform (e.g., continuous wave waveform) with a frequency as best shown in FIG. 10. An oscillator 33 is coupled to the waveform generator 29 for changing the frequency of the waveform and outputting a heterodyned signal. A transmit amplifier 37 is coupled to the oscillator 33 to amplify the heterodyned signal and output an amplified heterodyne signal. The radar based gesture recognition subassembly 25 also includes a splitter 41 having a splitter input 43 coupled to the transmit amplifier 37 and a plurality of splitter outputs 45 for splitting the amplified heterodyne signal at the plurality of splitter outputs 45. At least one transmit antenna element 31 is coupled to one of the plurality of splitter outputs 45 for emitting emitted radar waves (e.g., an emitted continuous wave 54e) corresponding to the amplified heterodyne signal to provide an intermediate radar field (i.e., detection zone 62) within a predetermined distance D from the radar based gesture recognition subassembly 25 (e.g., from the rear bumper 18 of the vehicle 12). The intermediate radar field enables the user 24 to interact, from a distance (e.g., within predetermined distance D), with various gestures or motions including by not limited to, hand gestures, foot gestures, and/or full body gestures. Gestures could include motion, non-motion, or a combination thereof. As indicated, the emitted radar waves emitted by the radar based gesture recognition subassembly 25 shown in FIG. 10 are continuous wave (CW) radar (i.e., the waveform generator 29 generates a continuous wave waveform), known in the art to use Doppler radar for providing a lower cost and simpler motion/object detection system 10. Nevertheless, it should be understood that the radar based gesture recognition subassembly 25 can be configured to continuously emit modulated radiation, ultra-wideband radiation, or sub-millimeter-frequency radiation (e.g., frequencies forming part of the industrial, scientific and medical (ISM) frequency band about 24 GHz or 60 GHz as examples).

The radar based gesture recognition subassembly 25 also includes at least one receive antenna element 35 for receiving the reflections of, or sense the interactions within the intermediate radar field (i.e., the emitted radar waves from the at least one transmit antenna element 31). A first receive amplifier 47 is coupled to the one receive antenna element 35 for amplifying the reflections of the emitted radar waves and outputting an amplified reflected wave signal. A mixer 49 is coupled to another of the plurality of splitter outputs 45 of the splitter 41 and to the first receive amplifier 47 for mixing the amplified heterodyne signal and the amplified reflected wave signal to generate a mixed receive signal. The radar based gesture recognition subassembly 25 additionally includes a second receive amplifier 50 coupled to the mixer 49 for amplifying the mixed receive signal and outputting an amplified mixed receive signal. A signal processor 27 is coupled to the second receive amplifier 50 for receiving and processing the amplified mixed receive signal (i.e., the received reflected CW radar signal) to determine frequency shifts of the emitted radar waves (e.g., continuous wave 54e) indicative of a speed V of the object or user 24. The signal processor 27 can also be coupled to the electronic control unit 32 or alternatively be integrated in the electronic control unit 32. The signal processor 27 is disposed in communication with the at least one receive antenna element 35 for processing the received reflections or the reflections of the emitted radar waves (i.e., the signal processor 27 can execute instructions to perform calculations on the received reflection and transmitted radiation signals or mixed signals to implement the various detection techniques including, but not limited to CW Radar, frequency modulated continuous wave Radar, time of flight) within the intermediate radar field to provide motion and/or gesture data for determining the gesture made by the user 24.

So, the radar based gesture recognition subassembly 25 shown in FIG. 10 can be configured to emit and detect continuous wave (CW) radar with one transmit antenna element 31 and one receive antenna element 35. With such a configuration, the radar based gesture recognition subsystem 25 is operable to detect a speed/velocity V of the object/user 24 using the Doppler Radar principles (i.e., processing by the signal processor 27 of the received reflected CW radar signal to determine frequency shifts of the emitted continuous wave 54e) indicative of the speed V of the object or user 24).

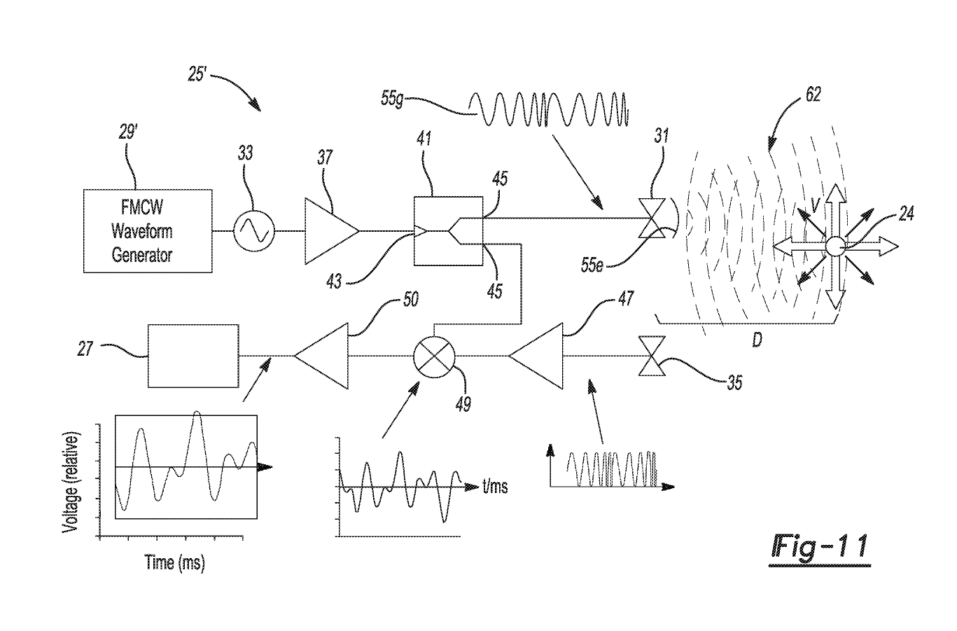

As illustratively shown in FIG. 11, another example radar based gesture recognition subassembly 25′ can be also configured to emit and receive frequency modulated continuous wave (FMCW) radar, with the radar based gesture recognition subassembly 25′ including one transmit antenna element 31 and one receive antenna element 35. The structure of the radar based gesture recognition subassembly 25′ is similar to the radar based gesture recognition subassembly 25 shown in FIG. 10, however, the waveform generator 29′ instead outputs a frequency modulated continuous wave waveform to emit a frequency modulated continuous wave 55e with the transmit antenna element 31. With such a configuration, the radar based gesture recognition subassembly 25′ is operable to detect a gesture/motion of the object/user 24 using the Frequency Modulated Radar techniques (i.e., processing by the signal processor 27 of the reflected FMCW radar signal to determine frequency shifts indicative of the speed V or Doppler frequency and distance/range or beat frequency of the object/user 24).

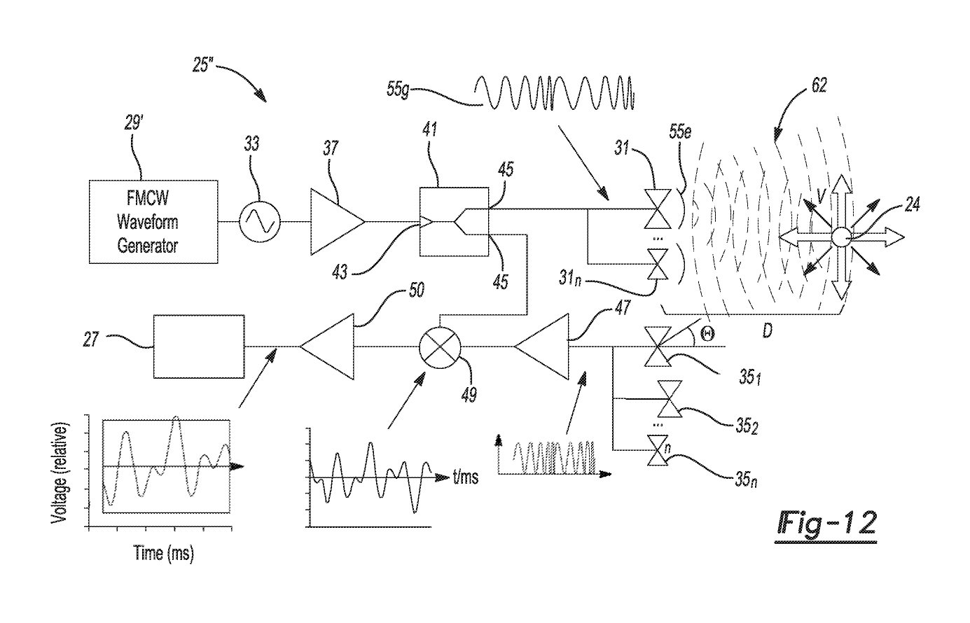

As illustratively shown in FIG. 12, another example radar based gesture recognition subassembly 25″ also utilizes FMCW radar and the at least one receive antenna 35 can include a plurality of receive antenna elements 35₁, 35₂, to 35ₙ forming a receive antenna array. The use of the plurality of receive antenna elements 35₁, 35₂, to 35ₙ is advantageous because the angle θ of the reflections of the emitted radar waves can vary for each of the plurality of receive antenna elements 35₁, 35₂, to 35ₙ depending on the position of the object/user 24 relative to each the plurality of receive antenna elements 35₁, 35₂, to 35ₙ. Thus, the use of the plurality of receive antenna elements 35₁, 35₂, to 35ₙ can provide more a more accurate estimate of the position of the object/user 24. Also, the at least one transmit antenna 31 can include a plurality of transmit antenna elements 31 to 31ₙ forming a transmit antenna array may be provided. It should be appreciated that the radar based gesture recognition subassembly 25, 25′, 25″ may instead be configured for pulsed time-of-flight radar.

The intermediate radar field or detection zone 62 provided by the at least one transmit antenna 31 can be a three-dimensional volume, e.g. hemispherical shape, cube, cone, or cylinder. Again, the at least one receive antenna element 35 is used to receive reflections from interactions in the intermediate radar field and the signal processor 27 is used to process and analyze the received reflections to provide gesture data usable to determine gestures for opening the rear liftgate 14 or other closure member. To sense gestures through obstructions, the radar based gesture recognition subassembly 25, 25′, 25″ can be configured to emit radar waves capable of substantially penetrating fabric, wood, plastic, and glass, as well as other non-metallic material. The at least one receive antenna element 35 can be configured to receive the reflections from the human tissue through the fabric of a user's clothing, as well as through plastic, ice, rain, snow, dirt, wood, and glass.

So, according to the example embodiment, as the user 24 approaches the vehicle 12, the vehicle 12 senses the key fob 22 and activates the radar based gesture recognition system and the indicator 28. The radar based gesture recognition system has a triggering event mode and a non-triggering event mode. The indicator 28 in accordance with the example embodiment is a light disposed on the rear bumper 18 to notify the user 24 that the system 10 is activated and waiting for the activation gesture from the user 24 to open the closure member (e.g., rear liftgate 14). The indicator 28 also notifies the user 24 of the correct position to perform the activation gesture (e.g., the presence of a foot of the user 24). At the same time, the radar based gesture recognition subassembly 25, 25′, 25″ produces the intermediate radar field adjacent to the indicator and the vehicle 12.

For the example embodiment, the indicator notifies the user 24 by illuminating a red light. To initiate the triggering event mode, the user 24 places his or her foot under the lighted indicator 28. When the user 24 places his or her foot under the lighted indicator 28 (e.g. such a motion may be a natural and intuitive “step-in” involving moving his or her foot into the detection zone 62 in a motion equivalent to a step, which an initial entry into the detection zone 62 at a position above the ground 83, followed by a motion towards the ground 83 and towards the vehicle 12, and finally the motion terminating with the foot contacting the ground 83 in the detection zone 62), the at least one receive antenna element 35 of the radar based gesture recognition subassembly 25, 25′, 25″ receives reflections from interactions in the intermediate radar field. Then, the signal processor 27 processes and analyzes the received reflections to provide gesture data usable to determine the gesture. For example, the signal processor 27 can process the received reflection to determine a Doppler shift for calculating the speed/velocity V of the object or user 24, or a frequency shift for calculating the distance and speed of the object or user 24, as well as angle and directional changes which may indicate a vertical change for example indicating a the object or user 24 is moving towards the ground 83 Intensities of the reflected radar signal may also be processed to determine the size of the user or object 24. For the signal processor 27 to process the received reflections to conclude the activation gesture has been made, the user 24 may have to leave his or her foot stationary for a require period of time (e.g., four seconds). Once the user 24 leaves his or her foot stationary for the required period of time and the proper gesture is provided, the indicator 28 notifies the user by flashing an illuminated yellow light. In this example, the gesture consists of a sequential combination of a motion into the detection zone 62, and a non-movement of the foot in the detection zone 62. Next, the system 10 initiates movement of the closure member (e.g., the opening of the rear liftgate 14). On the other hand, if the user 24 leaves his or her foot stationary but does not meet the required period of time (e.g., less than four seconds) needed to initiate the opening of the rear liftgate 14, the non-triggering event mode is initiated. During the non-triggering event, the indicator 28 quickly flashes the illuminated yellow light to indicate to the user 24 that the gesture made by the user 24 does not meet the requirement for opening the rear liftgate 14.

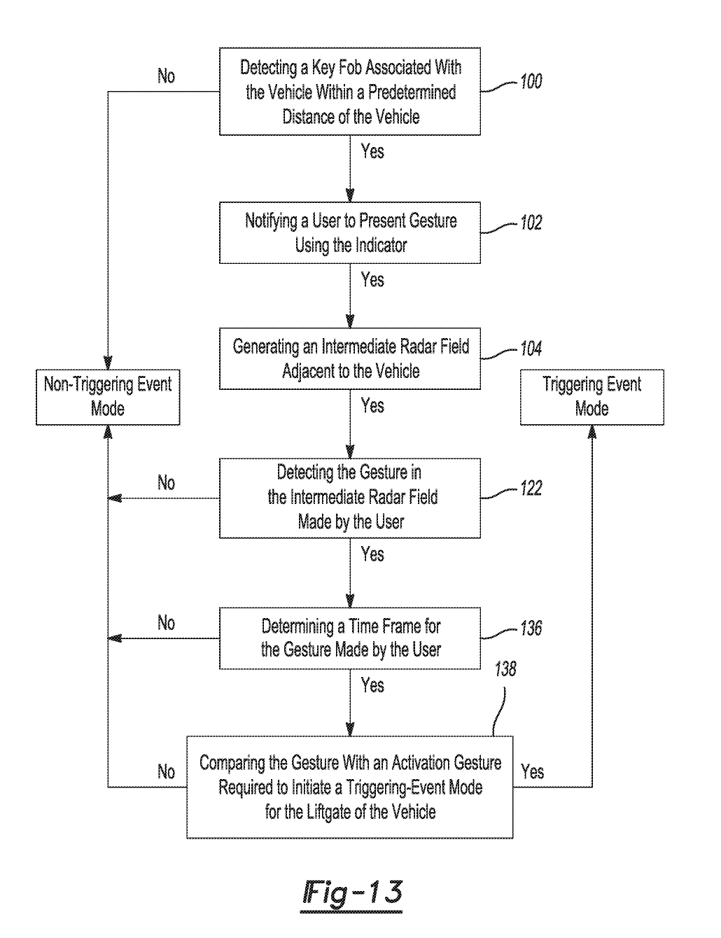

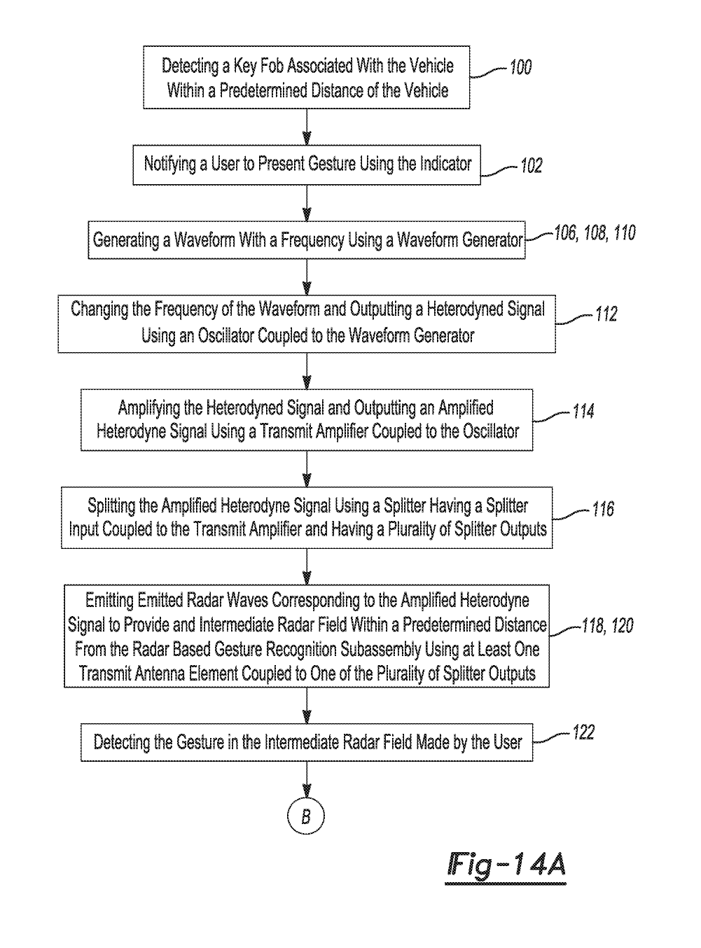

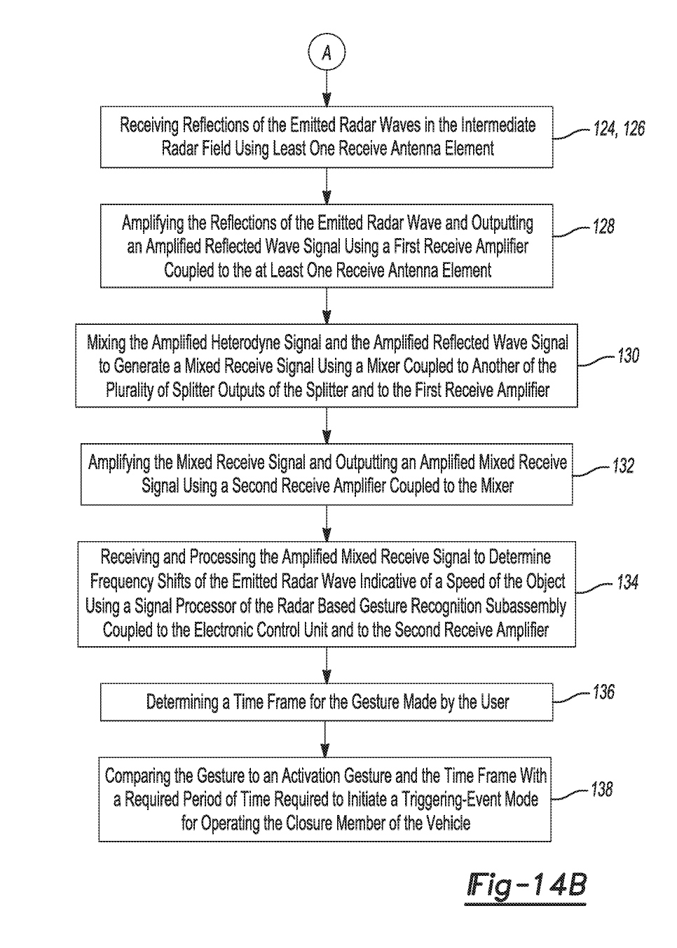

Thus, as best shown in FIGS. 13 and 14A-14B, a method for operating a closure member (e.g., liftgate 14) of a vehicle 12 using a non-contact power closure member system 10 including an indicator 28 and a non-contact sensor including a radar based gesture recognition subassembly 25, 25′, 25″ and an electronic control unit 32 is provided. The method includes the step of 100 detecting a key fob 22 associated with the vehicle 12 within a predetermined distance of the vehicle 12. Step 100 of detecting a key fob 22 may be performed by a Body Control Module (not shown) of the vehicle 12 in communication with the non-contact power closure member system 10, or by the non-contact power closure member system 10. Next, 102 notifying a user 24 to present a gesture using the indicator 28. For the example embodiment, the indicator 28 can illuminate a red light to the user 24 to notify the user 24 to present the gesture which is required to initiate opening of the rear liftgate 14. The method proceeds by 104 generating an intermediate radar field adjacent to the vehicle 12 using the radar based gesture recognition subassembly 25, 25′, 25″. In more detail, the step of 104 generating the intermediate radar field adjacent to the vehicle 12 using the radar based gesture recognition subassembly 25, 25′, 25″ can include the steps of 106 generating a waveform with a frequency using a waveform generator 29. In the event that the waveform generator 29 outputs a continuous wave waveform 54g, the step of 106 generating the waveform with the frequency using the waveform generator 29 includes 108 generating a continuous wave waveform 54g with the frequency using the waveform generator 29. Alternatively, the step of 106 generating the waveform with the frequency using the waveform generator 29 can include 110 generating a frequency modulated continuous wave waveform 55g with the frequency using the waveform generator 29.

The step of 104 generating the intermediate radar field adjacent to the vehicle 12 using the radar based gesture recognition subassembly 25, 25′, 25″ can include the step of 112 changing the frequency of the waveform and outputting a heterodyned signal using an oscillator 33 coupled to the waveform generator 29. The step of 104 generating the intermediate radar field adjacent to the vehicle 12 using the radar based gesture recognition subassembly 25, 25′, 25″ can also include the steps of 114 amplifying the heterodyned signal and outputting an amplified heterodyne signal using a transmit amplifier 37 coupled to the oscillator and 116 splitting the amplified heterodyne signal using a splitter 41 having a splitter input 43 coupled to the transmit amplifier 37 and having a plurality of splitter outputs 43.

The step of 104 generating the intermediate radar field adjacent to the vehicle 12 using the radar based gesture recognition subassembly 25, 25′, 25″ can additionally include the step of 118 emitting emitted radar waves corresponding to the amplified heterodyne signal to provide an intermediate radar field within a predetermined distance D from the radar based gesture recognition subassembly 25, 25′, 25″ using at least one transmit antenna element 31 coupled to one of the plurality of splitter outputs 43. In more detail, the step of 118 emitting emitted radar waves corresponding to the amplified heterodyne signal to provide an intermediate radar field within a predetermined distance D from the radar based gesture recognition subassembly 25, 25′, 25″ using at least one transmit antenna element 31 coupled to one of the plurality of splitter outputs 43 can include the step of 120 emitting emitted radar waves corresponding to the amplified heterodyne signal to provide an intermediate radar field within a predetermined distance D from the radar based gesture recognition subassembly 25, 25′, 25″ using the plurality of transmit antenna elements 31 to 31ₙ coupled to the one of the plurality of splitter outputs 43.

The method can continue by 122 detecting the gesture in the intermediate radar field made by the user 24. Thus, the method can also include the step of 124 receiving reflections of the emitted radar waves in the intermediate radar field using least one receive antenna element 35. As discussed above, the at least one receive antenna element 35 can include a plurality of receive antenna elements 35₁, 35₂, to 35ₙ, thus, the step of 124 receiving reflections of the emitted radar waves in the intermediate radar field using the at least one receive antenna element 35 can include 126 receiving reflections of the emitted radar waves in the intermediate radar field using a plurality of receive antenna elements 35₁, 35₂, to 35ₙ. The next step of the method is 128 amplifying the reflections of the emitted radar wave and outputting an amplified reflected wave signal using a first receive amplifier 47 coupled to the at least one receive antenna element 35. The method can proceed with the steps of 130 mixing the amplified heterodyne signal and the amplified reflected wave signal to generate a mixed receive signal using a mixer 49 coupled to another of the plurality of splitter outputs 43 of the splitter 41 and to the first receive amplifier 47 and 132 amplifying the mixed receive signal and outputting an amplified mixed receive signal using a second receive amplifier 50 coupled to the mixer 49. The method can continue with the step of 134 receiving and processing the amplified mixed receive signal to determine frequency shifts of the emitted radar wave indicative of a speed V of the object 24 using a signal processor 27 of the radar based gesture recognition subassembly 25, 25′, 25″ coupled to the electronic control unit 32 and to the second receive amplifier 50. Other motion and gesture information such as distance/range, direction/angle, and size of the object 24 may also be determined through the processing of the amplified mixed receive signal at step 134.

The method also includes the steps of 136 determining a time frame for the gesture made by the user and 138 comparing the gesture to an activation gesture and the time frame with a required period of time required to initiate a triggering-event mode for operating the closure member 14 of the vehicle 12 (typically conducted by software incorporated into the system 10 and executed by the electronic control unit 32).

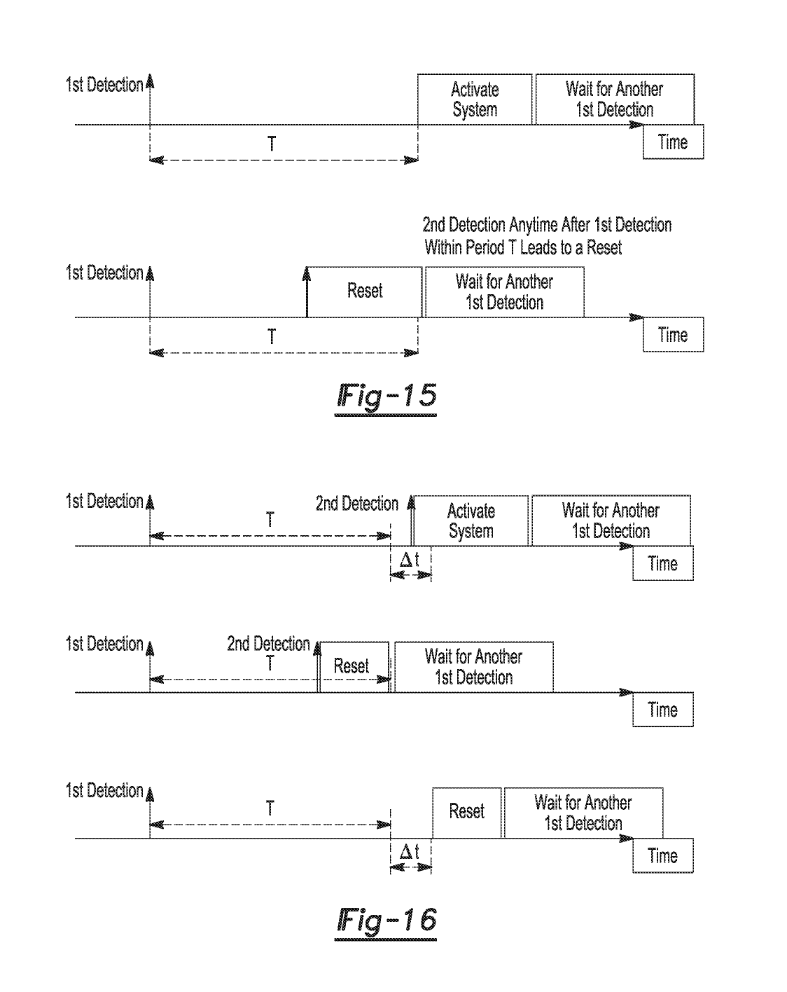

It should be appreciated that various techniques may be used for the detecting the interactions in the intermediate radar field. For the example embodiment, as illustrated in FIG. 15, the gesture technique is based on motion detection. As shown in FIG. 15, to unlock or actuate the system 10 (door or liftgate 14) the user 24 has put his or her foot in the range of the radar zone (e.g., the intermediate radar field), and then wait a period of time T before moving his or her foot out of the range of the radar to activate the system 10. In other words, the user 24 must put his or her foot in the intermediate radar field for the required period of time T before removing his or her foot. No movements, or substantial movements are allowed within the period T after the first detection. If the system 10 detects a second movement within the period T, the algorithm will ignore the first detection and go to a reset state and then wait for a new input, or a new gesture (e.g., a new step-in). During the required period of time T, to activate the system 10, it is preferred that the user 24 makes no additional movements in the intermediate radar field. If the system 10 detects a second interaction, i.e. an additional movement made by the user 24, in the intermediate radar field within the required period of time T, the first interaction detected by the at least one receive antenna element 35 will be ignored by the system 10 and the system 10 will reset and wait for a new interaction made by the user 24.

Alternatively, in accordance with another example embodiment, as illustrated in FIG. 16, a dual motion detection technique may be employed for detecting interactions in the intermediate radar field. To activate the system 10, the user 24 should provide a first interaction in the intermediate radar field (e.g., put his or her foot in the intermediate radar field). As shown in FIG. 16, to unlock or actuate the system 10, the user 24 puts his foot in the range of the radar zone and then removes it within the time T and T+Δt to activate the system 10. After providing the first interaction, the user should provide a second interaction in the intermediate radar field within the required period of time T plus a time delay Δt (e.g., quickly removing his or her foot from the intermediate radar field). However, no second detections are allowed after the first detection and before T. If the system 10 detects a second movement, the algorithm will ignore the first detection and go to a reset state and wait for a new input. During the required period of time T, it is preferred that the user 24 should not make additional interactions in the intermediate radar field. If the system 10 detects a second interaction in the intermediate radar field during the required period of time T, the first interaction detected by the at least one receive antenna element 35 will be ignored by the system 10 and the system 10 will reset and wait for a new interaction made by the user 24. Similarly, if there is no second detection after the expiration of the allowed time T+Δt, the algorithm will ignore the first detection and go to a reset state and then wait for a new input. In other words, if the system 10 detects no second interaction within the time delay Δt after the required period of time T, the system 10 will reset and wait for a new interaction made by the user 24. It should be appreciated that the system 10 including radar based gesture recognition subassembly 25, 25′, 25″ can be used in connection with other applications including non-contact (i.e., gesture based) activation of power opening closures such as power doors, power trunks, frunks (i.e., powered activation of a front hood enclosing a front storage compartment) and power sliding doors (i.e., minivans). In addition, these techniques could also apply to other non-automotive applications that could benefit from gesture based activation of systems.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top,” “bottom,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A user-activated non-contact closure member system for detecting a gesture and operating a closure member a vehicle, comprising:
at least one non-contact sensor attached to a vehicle body for detecting at least one of an object and motion corresponding to the gesture made by a user and outputting data in response to detecting the at least one of the object and the motion;
said at least one non-contact sensor including a radar based gesture recognition subassembly for providing an intermediate radar field within a predetermined distance from said radar based gesture recognition subassembly in which the user can interact;
an indicator attached to the vehicle body for informing the user of an appropriate location to make the gesture;
an electric control unit coupled to said indicator and said at least one non-contact sensor and configured to:
receive and analyze the data output by said at least one non-contact sensor,
determine whether the data corresponds with an activation gesture to transition to a triggering event mode defined by the gesture made by the user corresponding to the activation gesture and a non-triggering event mode defined by the gesture not corresponding to the activation gesture,
initiate movement of the closure member in response to transitioning to the triggering event mode, and
notify the user using said indicator.

2. The system as set forth in claim 1, wherein said radar based gesture recognition subassembly includes a waveform generator for generating a waveform with a frequency and an oscillator coupled to said waveform generator for changing the frequency of the waveform and outputting a heterodyned signal.

3. The system as set forth in claim 2, wherein said radar based gesture recognition subassembly includes:
a transmit amplifier coupled to said oscillator to amplify the heterodyned signal and output an amplified heterodyne signal;
a splitter having a splitter input coupled to said transmit amplifier and having a plurality of splitter outputs for splitting the amplified heterodyne signal at said plurality of splitter outputs; and
at least one transmit antenna element coupled to one of said plurality of splitter outputs for emitting emitted radar waves corresponding to the amplified heterodyne signal to provide an intermediate radar field within a predetermined distance from said radar based gesture recognition subassembly.

4. The system as set forth in claim 3, wherein said at least one transmit antenna element includes a plurality of transmit antenna elements.

5. The system as set forth in claim 3, wherein said waveform generator outputs a continuous wave waveform to allow said radar based gesture recognition subassembly to emit an emitted continuous wave with said at least one transmit antenna element.

6. The system as set forth in claim 3, wherein said waveform generator outputs a frequency modulated continuous wave waveform to allow said radar based gesture recognition subassembly to emit a frequency modulated continuous wave with said at least one transmit antenna element.

7. The system as set forth in claim 3, wherein said radar based gesture recognition subassembly includes:
at least one receive antenna element for receiving reflections of the emitted radar wave in the intermediate radar field;
a first receive amplifier coupled to said at least one receive antenna element for amplifying the reflections of the emitted radar wave and outputting an amplified reflected wave signal;
a mixer coupled to another of said plurality of splitter outputs of said splitter and to said first receive amplifier for mixing the amplified heterodyne signal and the amplified reflected wave signal to generate a mixed receive signal; and
a second receive amplifier coupled to said mixer for amplifying the mixed receive signal and outputting an amplified mixed receive signal.

8. The system as set forth in claim 7, wherein said at least one receive antenna element includes a plurality of receive antenna elements.

9. The system as set forth in claim 3, wherein said radar based gesture recognition subassembly includes a signal processor coupled to said electronic control unit and to said second receive amplifier for receiving and processing the amplified mixed receive signal to determine frequency shifts of the emitted radar wave indicative of a speed of the object.

10. The system as set forth in claim 1, wherein said radar based gesture recognition subassembly is configured to emit and receive at least one of ultra-wideband radiation and sub-millimeter-frequency radiation.

11. The system as set forth in claim 1, wherein the closure member is a rear liftgate of the vehicle and said radar based gesture recognition subassembly and said indicator are attached to a rear bumper of the vehicle.

12. A method for operating a closure member of a vehicle using a non-contact power closure member system including an indicator and a non-contact sensor including a radar based gesture recognition subassembly and an electronic control unit, comprising the steps of:
detecting a key fob associated with the vehicle within a predetermined distance of the vehicle;
notifying a user to present a gesture using the indicator;
generating an intermediate radar field adjacent to the vehicle using the radar based gesture recognition subassembly;
detecting the gesture in the intermediate radar field made by the user;
determining a time frame for the gesture made by the user; and
comparing the gesture to an activation gesture and the time frame with a required period of time required to initiate a triggering-event mode for operating the closure member of the vehicle.

13. The method as set forth in claim 12, wherein the step of generating the intermediate radar field adjacent to the vehicle using the radar based gesture recognition subassembly includes the steps of:
generating a waveform with a frequency using a waveform generator; and
changing the frequency of the waveform and outputting a heterodyned signal using an oscillator coupled to the waveform generator.

14. The method as set forth in claim 13, wherein the step of generating the intermediate radar field adjacent to the vehicle using the radar based gesture recognition subassembly includes the steps of:
amplifying the heterodyned signal and outputting an amplified heterodyne signal using a transmit amplifier coupled to the oscillator;
splitting the amplified heterodyne signal using a splitter having a splitter input coupled to the transmit amplifier and having a plurality of splitter outputs; and
emitting emitted radar waves corresponding to the amplified heterodyne signal to provide an intermediate radar field within a predetermined distance from the radar based gesture recognition subassembly using at least one transmit antenna element coupled to one of the plurality of splitter outputs.

15. The method as set forth in claim 13, wherein the step of emitting emitted radar waves corresponding to the amplified heterodyne signal to provide an intermediate radar field within a predetermined distance from the radar based gesture recognition subassembly using at least one transmit antenna element coupled to one of the plurality of splitter outputs includes the step of emitting emitted radar waves corresponding to the amplified heterodyne signal to provide an intermediate radar field within a predetermined distance from the radar based gesture recognition subassembly using a plurality of transmit antenna elements coupled to the one of the plurality of splitter outputs.

16. The method as set forth in claim 13, wherein the step of generating the waveform with the frequency using the waveform generator includes generating a continuous wave waveform with the frequency using the waveform generator.

17. The method as set forth in claim 13, wherein the step of generating the waveform with the frequency using the waveform generator includes generating a frequency modulated continuous wave waveform with the frequency using the waveform generator.

18. The method as set forth in claim 13, further including the steps of:
receiving reflections of the emitted radar waves in the intermediate radar field using at least one receive antenna element;
amplifying the reflections of the emitted radar wave and outputting an amplified reflected wave signal using a first receive amplifier coupled to the at least one receive antenna element;
mixing the amplified heterodyne signal and the amplified reflected wave signal to generate a mixed receive signal using a mixer coupled to another of the plurality of splitter outputs of the splitter and to the first receive amplifier; and
amplifying the mixed receive signal and outputting an amplified mixed receive signal using a second receive amplifier coupled to the mixer.

19. The method as set forth in claim 18, wherein the step of receiving reflections of the emitted radar waves in the intermediate radar field using the at least one receive antenna element antenna element includes receiving reflections of the emitted radar waves in the intermediate radar field using a plurality of receive antenna elements.

20. The method as set forth in claim 18, further including the step of receiving and processing the amplified mixed receive signal to determine frequency shifts of the emitted radar wave indicative of a speed of the object using a signal processor of the radar based gesture recognition subassembly coupled to the electronic control unit and to the second receive amplifier.

21. A method for operating a closure member of a vehicle using a non-contact power closure member system including an indicator and at least one non-contact sensor coupled to an electronic control unit, comprising the steps of:
detecting movement of an object adjacent the closure member and outputting data associated with the object using the at least one non-contact sensor;
determining that there is a first detection associated with the detecting the movement of the object moved adjacent the closure member and outputting data associated with the object;
determining whether the object remains adjacent the closure member with no additional movement of the object within a required amount of time after the first detection and outputting data associated with the object;
ignoring the first detection and transitioning to a reset state and returning to the steps of determining that there is a first detection and whether the object remains adjacent the closure member with no additional movement of the object within the required amount of time after the first detection;
initiating movement of the closure member in response to determining that there is the first detection and that is no second detection within the required amount of time after the first detection; and
notifying the user using the indicator in response to one of initiating movement of the closure member and ignoring the first detection.

22. The method as set forth in claim 21, further including the step of determining that there is a second detection associated with movement of the object in which the object does not remain adjacent the closure member, and determining whether the second detection occurs after the required amount of time after the first detection.

23. The method as set forth in claim 22, further including the step of determining whether the second detection occurs within the required amount of time and a time a delay after the required amount of time and wherein the step of initiating movement of the closure member in response to determining that there is the first detection and that is no second detection within the required amount of time after the first detection is further defined as initiating movement of the closure member in response to determining that there is the first detection and that is the second detection within the required amount of time and the time delay after the required amount of time.

24. The method as set forth in claim 22, further including the steps of:
determining whether the second detection occurs within the required amount of time and a time delay after the required amount of time; and
transitioning to the reset state and returning to the steps of determining that there is a first detection in response to determining that there is no second detection within the required amount of time and the time delay after the required amount of time.
